(19) United States
(12) Patent Application Publication
(10) Pub. No.: US 2017/0195336 A1
(43) Pub. Date: Jul. 6, 2017

(54) Method and System for Non-Authoritative Identity and Identity Permissions Broker and Use Thereof

(71) Applicant: Sensormatic Electronics, LLC, Boca Raton, FL (US)

(72) Inventor: Jason M. Ouellette, Southbridge, MA (US)

(21) Appl. No.: 14/988,472

(22) Filed: Jan. 5, 2016

(51) Int. Cl. H04L 29/06

(52) U.S. Cl. CPC H04L 63/102; H04L 63/0861

(57) ABSTRACT

A credentialing system comprises an identity source storing identity attributes for users, identity wallets for users that enable access to the identity attributes in the identity source, and identity brokers for accessing the identity source on behalf of access control systems of organizations. This system can address both the data privacy and trust issues allowing a non-authoritative identity source in a distributed environment to be used for all identity purposes through the ability to broker the identity and attributes of the identity across any number of physical or logical credentials and across different organizations. The system further implements an identity score stored along with identity attributes. The score rates the strength of the identity from the global non-authoritative source.

### BACKGROUND OF THE INVENTION

Access control readers are often installed throughout the buildings to control access to restricted areas, such as buildings or areas of the buildings. The access control readers read credentials of users (e.g., keycards) and then permit those authenticated and authorized users to access the restricted areas. In one example, users interact with the access control readers by swiping keycards or bringing contactless, smart cards within range (approximately 2-3 inches or 5 centimeters) of the reader. In another example, users present credentials such as usernames and passwords or tokens stored on fobs or mobile computing devices, e.g., mobile phones of the users. The devices wirelessly communicate the users' credential information to the access control readers when the devices are within range of a threshold area of a portal to a restricted area.

For physical access control, the reader reads the user credential information from the keycards or devices and then the associated access control system determines if the users are authorized to access the restricted areas by reference to the obtained credential information. If the users are authorized to enter the restricted areas, then the access control readers allow access to the restricted areas by unlocking locked doors, signaling that doors should be unlocked, or not generating alarm upon user entry, for example.

More generally, commercial and governmental organizations use credentials to negotiate physical and logical access control privileges in many other contexts, besides door/restricted area access. For example, database access may require a username and password or possibly a keycard or other credential. Similar credentials may be required for access control systems for sensitive human resource files. These contexts are typically controlled by one or more credentialing systems.

### SUMMARY OF THE INVENTION

Security systems installed in business settings and government buildings, and modern residential dwellings as well as enterprise networks typically create their own version of electronic credentials for users that enable the users to obtain access to their respective premises or network resources. While some companies and government agencies provide the ability for users to gain access to multiple buildings or sites connected to the same enterprise network using the same electronic credential, the scope of access provided by an electronic credential is limited to those sites under the dominion and control of the same entity that generated the credential and, in general, does not cross the enterprise boundaries to other companies, organizations, governments, etc.

In more detail, most companies or other organizations, for example, maintain a database of identification credentials for their users (e.g., employees) in a central or distributed authoritative source. Those credentials are often unique within the company and provide employees with physical and logical access control privileges. However, those credentials are meaningless outside the company, as the company has no rights to some of the information contained in or associated with the credentials (e.g., social security information). Further, the company has a responsibility to keep all data private meaning the company cannot use or license the data for any other purposes beyond the company.

As a result of this situation, there is a wealth of information that could otherwise be used if the data privacy and trust of the identity could be addressed. This invention proposes to address both the data privacy and trust issues allowing a non-authoritative identity source in a distributed environment to be used for all identity purposes through the ability to broker the identity and attributes of the identity across any number of physical or logical credentials.

At a high level, the invention is embodied in the idea of an identity score stored along with identity attributes in a non-authoritative and global source which is accessible through an identity wallet, and a universal identity broker service that associates identity information that can be used to substantiate a person's identity for both physical and logical purposes. The substantiation takes the form of an overall “identity score” which rates the strength of the identity from the global non-authoritative source.

In general according to one aspect, the invention features a credentialing system such as might be used in a security system. It comprises an identity source storing identity attributes for users, identity wallets for users that enable access to the identity attributes in the identity source, and identity brokers for accessing the identity source on behalf of access control systems of organizations.

In embodiments, the system further includes an identity score engine for generating an identity score for each of the users that rates the strength of the identity of the users embodied by the identity attributes and transactions stored in the identity source for each of the users. Preferably, the identity score is stored in the identity source. Then in operation, the identity brokers access the identity score and will block access to users at the access control system that have an inadequate identity score.

Typically, the identity brokers access the identity source on behalf of access control systems of organizations. The identity brokers access the identity attributes based on authority granted via the identity wallets.

The identity source can be non-authoritative system that is utilized by different organizations such as multiple companies and/or governmental entities. It is preferably distributed over multiple nodes. Specifically, the identity attributes may be stored in block chain.

Biometric readers are preferably used to provide access to the identity wallets by the users. Typically, the identity wallets would be stored on mobile computing devices.

In general according to another aspect, the invention also features a credentialing method. The method comprises storing identity attributes for users in an identity source accessible by multiple organizations, the users enabling access to the identity attributes in the identity source via identity wallets, and identity brokers accessing the identity source on behalf of access control systems of the organizations.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a block diagram of credentialing system including an identity broker; and

FIG. 2 is a flow diagram illustrating access control utilizing the identity broker.

### DETAILED DESCRIPTION OF THE PREFERRED EMBODIMENTS

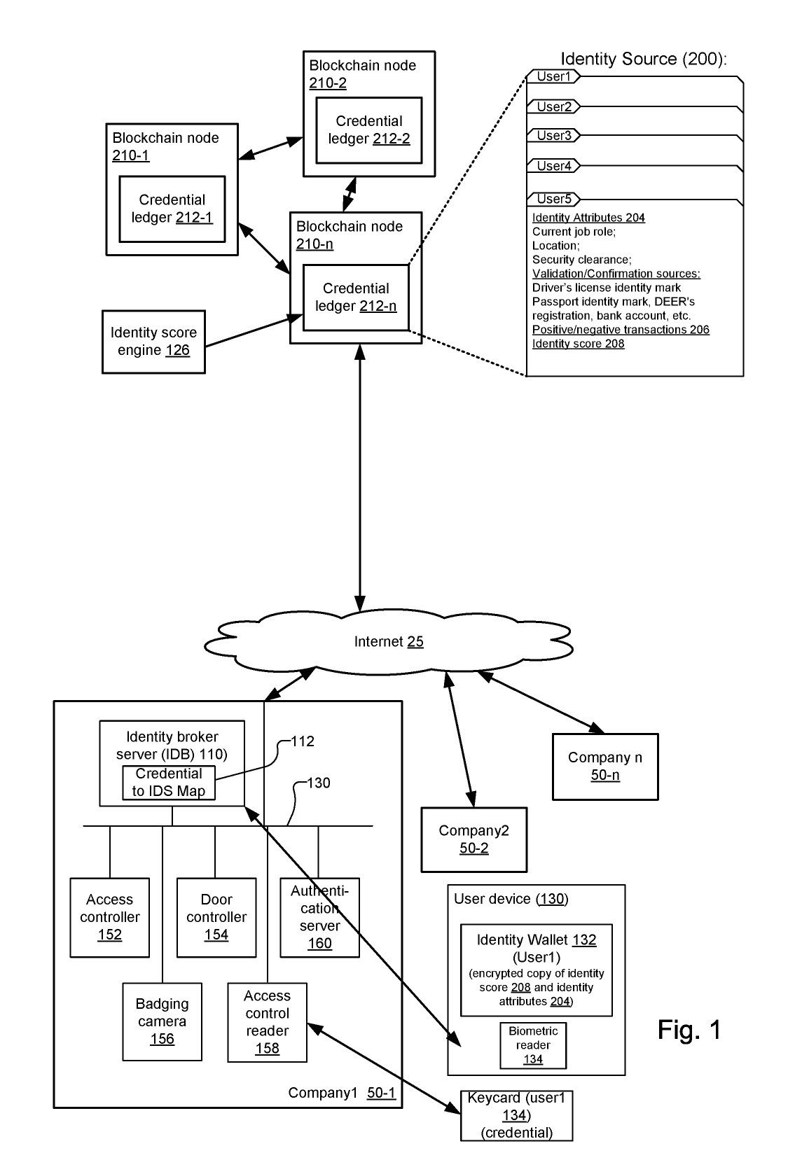

FIG. 1 shows a credentialing system including an identity broker, which has been constructed according to the principles of the present invention.

In general, a number of organizations such as different business entities 50-1, 50-2, 50-3 and/or governmental entities access a common identity source 200.

In the preferred embodiment, the identity source 200 is stored as credential ledger 212. Preferably, multiple versions of the ledger 212-1, 212-2, 212-n are stored in a number of nodes 210-1, 210-2, 210-n in the form of a block chain. In general, the ledger 212 is a permissionless distributed database that maintains a continuously growing list of transactional data records. The blockchain records are encrypted and stored on node computers systems 210-1, 210-2, 210-n.

In general, there are three classes of information in the credential ledger 212 for each user: identity attributes 204, transactions 206, and an identity score 208. This information is stored in the block chain. Blocks record and confirm when and in what sequence the identity attributes 204 and transactions 206 of the users were incorporated into the credential ledger 212.

The information of users is passed between the nodes 210-1, 210-2, 210-n. The identity attributes 204, transactions 206, and an identity score 208 are incorporated into the credential ledger 212 maintained by each of the nodes.

In the preferred embodiment, the identity source 110 moves away from a centralized system to a de-centralized or distributed identity which is not owned by any single authoritative source other than the users who own the identity or the organizations that require access to the identity attributes 204.

Within or for each organization 50-1, 50-2, 50-n, there is an identity broker server (IDB) 110 and components of access control system(s). They are interconnected via an enterprise network 130. An internet/intranet network cloud 25 provides data connections to the blockchain nodes 210-1, 210-2, 210-n.

The Identity Broker 110 is preferably a local server/service which communicates with identity wallets and any integrated access system that potentially needs to transact a decision (what is described as lock/unlock, on/off, true/false, yes/no or similar binary 1/0 answer) based on an identity. The broker 110 allows for credentials both logical and physical to be mapped to the Identity Source 200.

In general, the access control systems encompass logical and physical forms of access within each of the associated organizations 50-1, 50-2, 50-n as part of their larger security systems. One or more access controllers 152 will often administrate the systems. Access control readers 158 are often located near doors or other portals to read credential information from keycards or mobile computing devices (smart phones). In other cases, badging cameras 156 are used to gather information from the users. This credential information is passed to the access controller 152. If the credentials are found to be valid, then the door controller, for example, might be signaled to enable the keycard user/owner to enter a secured area.

In other examples, other credential information may be gathered from other computing devices on the network 130 such as client and server computers. This information is passed to authentication servers 160 that function as the access control system for the computer network. This might occur when a user wants to log-on to a device and/or to access a file or some other resource on the network 130, for example.

An identity score engine 126 generates an identity score for each potential user. This score is preferably created through transactions with official, legal identity providers such as the registry of motor vehicles, town hall for birth and death certificates, passport office, Department of Defense, banks, insurance companies, etc. Through an algorithm implemented by the engine 126, a score is generated for each user that is based on the various identity sources and the associated trust levels. This score and details are made available for the users of the score to determine the appropriate score level for their identity transaction.

In one example, this identity score is generated by each company or other organization based on a unique set of policies. In other examples, the engine 126 is maintained by a ratings agency, similar to a credit agency, to score the quality of the identity attributes 204 maintained for each of the users (User 1-User n) in the identity source 200, which is distributed over the credential ledgers 212-1, 212-2, 212-n. The “identity score” rates the strength of the identity from the identity source 200 by aggregating the validation of other official identity markers such as an issued driver license, passport, Defense Enrollment Eligibility Reporting System (DEERS) registration, bank account, and other related identity confirmation sources. In short, the score rates the likelihood that the person is who they say that they are.

An identity wallet 132 is further part of the credentialing system. It preferably utilizes biometrics and/or challenge/response for access to using, updating and transacting the identity. The identity wallet 132 is used to conduct the transactions between the users, the transaction target (IDB 110) and the identity source 200. Further, in a preferred embodiment, the identity wallet 132 also contains a copy of the user's/owner's identity score 208 and identity attributes 204 from the identity source 200. This copy is stored encrypted and allows for transactions to occur with the broker 110 when the broker cannot access the identity source 200 due to network connectivity issues, for example, or by option.

Each user has their own identity wallet 132. Typically the wallet or a pointer to the wallet is stored on a mobile user device 130. Preferably, the device 130 includes one or more biometric readers 134 and/or is password protected such that only the owner/user can access and control the wallet 132. The biometrics and/or password are preferably required for access to, using, updating and transacting the identity.

Credential information for the user in provided by control of the user device 130 such as by providing a token or radio frequency identification (RFID) code via the device 130 to the access control reader 158 or authentication server 160. In these case Bluetooth low energy (BLE), WIFI or near field communication can be utilized, to list a few examples. On other cases, the credential information can be provided via a standard keycard or badge 134 to the reader 158.

A credential to IDS map 112 is preferably maintained by the IDB 110. It maps the credential information read from the keycard 134 or transmitted by the user device 130 to the identity attributed of the associated user that is stored in the IDS 200 in the credential ledgers 212-1, 212-2, 212-n maintained by the nodes 210-1, 210-2, 210-n.

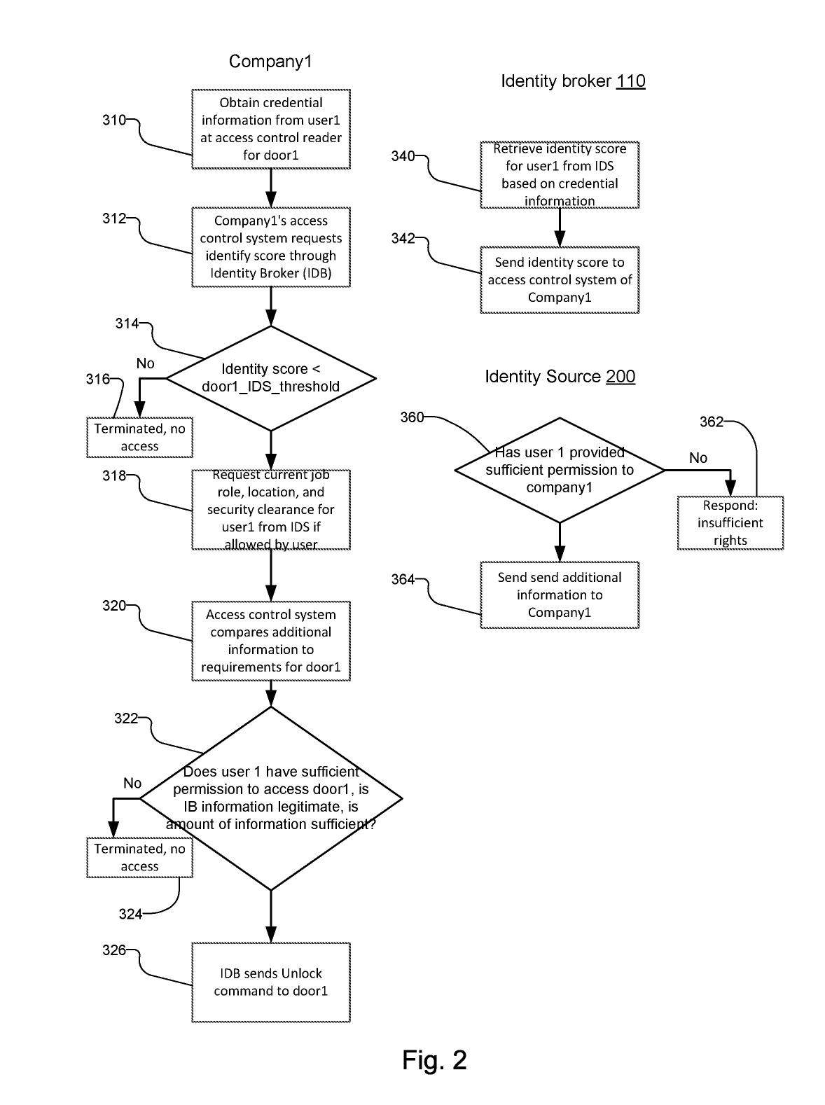

FIG. 2 illustrates access control in the credentialing system utilizing the identity broker (IDB) 110 and the identity source (IDS) 200.

The user presents their ID badge or keycard 134. These are forms of the avatar that represents the person's identity and provide credential information in step 310. The access control reader 158 provides the credential information to the identity broker 110 either directly or through the access controller 152.

The identity broker 110 uses the credential information as a lookup into the credential to IDS map 112 and then requests the identity score 208 of the associated user in step 312. In short, the access control system requests the identity score of the person with whom the ID Badge is associated, through the identity broker 110.

The score 208 is returned usually by the identity source 200 as it is stored in the credential ledgers 212. In step 340, the identity source 200 retrieves the identity score for the user and sends the identity score to the broker 110 in step 342.

In other examples, the score could be provided by other entities or it could be cached in the broker 110.

In still another example, the broker 110 retrieves an encrypted copy of the score 208 from the user's wallet 130. This source for the score 208 is accessed when the broker cannot retrieve the score from the IDS 200, for example.

If that score does not meet the requirements defined for the door or other physically or logical resource as determined by the access controller 152 or the broker 110 in step 314, then transaction is terminated and no access is provided in step 316.

On the other hand, if that score does meet the requirements defined for the door as determined by the access controller 152 or the broker 110 in step 314, then additional information related to transaction is requested from the identity source 200 by the broker 110 in step 318. In one example, the broker 110 requests identity attributes 204 such as the user's current job role, job location, security clearance, and positive and negative previous security transactions, for example, which are stored in the identity source 200.

The identity wallet 132 is used to define the permissions governing access to the access to the identity attributes 204 stored in the identity source 200 for the user. That is, the user must “allow” the required information of the request to be transmitted to the broker 110 of the specific company 50-1. The user's wallet 132 specifies the policies governing the availability of the identity attributes that will be made available to any specific organization.

In another example, the broker 110 retrieves an encrypted copy of the identity attributes 204 from the user's wallet 130. This source for the attributes 204 is accessed when the broker cannot retrieve the attributes from the IDS 200, for example.

The access controller 152 or the authentication server 160 checks the veracity of the information retrieved by the identity broker 110 from the identity source 200 and/or wallet 130 and compares it against the requirements for access to the door, for example, at which the ID Badge 134 was presented in step 320. Moreover, this verification can be done without the need to ever store the information in an owned or authoritative source such as in the organization.

In step 322, the granting of permissions and specifically the determination of whether the user has sufficient permission to access the door, for example, and whether the information is legitimate and whether the amount of information is sufficient, is determined by the broker 110, for example.

If the information provided does not meet the criteria sufficient for the transaction, the door will remain locked in step 324. The negative, failed transaction in some examples is reported back to the identification source 200 and stored in the credential ledger 212.

On the other hand, if the information meets the criteria, then the identity broker 110 sends on the unlock command to the door controller 154 either directly or through the access controller 152 in step 326. This positive, successful transaction in some examples is similarly reported back to the identification source 200 and stored in the credential ledger 212. In other examples, other access is given, such as access to a file via authorization provided via the authentication server 160, for example.

While this invention has been particularly shown and described with references to preferred embodiments thereof, it will be understood by those skilled in the art that various changes in form and details may be made therein without departing from the scope of the invention encompassed by the appended claims.

What is claimed is:

1. A credentialing system, comprising:
an identity source storing identity attributes for users;
identity wallets for users that enable access to the identity attributes in the identity source; and
identity brokers for accessing the identity source on behalf of access control systems of organizations.

2. The system according to claim 1, further comprising an identity score engine for generating an identity score for each of the users that rates the strength of the identity of the users embodied by the identity attributes stored in the identity source for each of the users.

3. The system according to claim 2, wherein the identity score is stored in the identity source.

4. The system according to claim 1, wherein the identity brokers access the identity score and will block access to users that have an inadequate identity score.

5. The system according to claim 1, wherein the identity brokers access the identity attributes based on authority granted via the identity wallets.

6. The system according to claim 1, wherein the identity source is distributed over multiple nodes.

7. The system according to claim 1, wherein the same identity source is utilized by multiple business and/or governmental entities.

8. The system according to claim 1, wherein the identity attributes are stored in a block chain.

9. The system according to claim 1, further comprising a biometric reader for providing access to the identity wallets.

10. The system according to claim 1, wherein the identity wallets are stored on mobile computing devices.

11. The system according to claim 1, wherein the identity brokers access the identity source on behalf of access control systems of organizations.

12. A credentialing method, comprising:
storing identity attributes for users in an identity source accessible by multiple organizations;
the users enabling access to the identity attributes in the identity source via identity wallets; and
identity brokers accessing the identity source on behalf of access control systems of the organizations.

13. The method according to claim 12, further comprising generating an identity score for each of the users that rates the strength of the identity of the users embodied by the identity attributes stored in the identity source for each of the users.

14. The method according to claim 13, wherein the identity score is stored in the identity source.

15. The method according to claim 12, wherein the identity brokers access the identity attributes based on authority granted via the identity wallets of the users.

16. The method according to claim 12, wherein the identity source is distributed over multiple nodes.

17. The method according to claim 12, wherein the identity attributes are stored in a block chain.

18. The method according to claim 12, further comprising reading biometric features of the users to provide access to the identity wallets.

19. The method according to claim 12, wherein the identity wallets are stored on mobile computing devices.

20. The method according to claim 12, further comprising the identity brokers accessing the identity source on behalf of access control systems of organizations.
